(19) United States
(12) Patent Application Publication
(10) Pub. No.: US 2006/0160652 A1
(43) Pub. Date: Jul. 20, 2006

(54) Spur gear differential

(75) Inventors: Gregory L. Maki, Solway, MN (US); Brandon P. Lenk, Shevlin, MN (US)

Correspondence Address: IPLM GROUP, P.A., POST OFFICE BOX 18455, MINNEAPOLIS, MN, 55418, US

(73) Assignee: TEAM Industries, Inc.

(21) Appl. No.: 11/035,690

(22) Filed: Jan. 14, 2005

(51) Int. Cl. F16H 48/06

(52) U.S. Cl. 475/248

(57) ABSTRACT

A spur gear differential (10) is used in a vehicle. The spur gear differential (10) includes a plurality of sets of planet gears (24a, 24b). The first planet gear (124a) is positioned to engage a first side gear (26) and a second planet gear (25) is positioned to engage a second side gear (25). A locking mechanism is also provided for locking the first side gear to the second side gear.

### BACKGROUND OF THE INVENTION

1. Field of the Invention

This invention relates generally to a spur gear differential and more particularly to a spur gear differential utilized in an all terrain vehicle (ATV) or utility vehicle.

2. Description of the Prior Art

The use of a differential in an ATV is well-known. However, as demands for better off-road abilities increases, there is a continuing demand for better designs of the differentials. A differential that has typically been used for an ATV has had a width that makes an ATV wider. It is desirous to have, at times, an ATV with a narrower width so that it may be hauled easier, such as in the bed of a pickup. When used with independent suspension, a wider differential will cause the angle of the suspension system to be greater. The operating angles of the half shafts of the suspension become too steep when the differential is wide and the width of the ATV is narrow. A narrower differential will allow for greater ground clearance, a smaller overall width and greater suspension travel. The present invention addresses problems with the prior art and provides for the use of a spur gear differential in an ATV or utility vehicle.

A conventional open differential allows for one wheel to spin out and limit torque transfer to the ground. The present invention provides for a differential that can be manually locked when desired or in another version includes means to automatically lock when wheel slip exceeds a preset amount. An automatic version will remain in the unlocked condition as long as torque is present and will unlock when torque is reversed.

### SUMMARY OF THE INVENTION

In one embodiment, the invention is a spur gear differential for use in a vehicle. The spur gear differential includes a differential housing having a first, carrier half, operatively connected to a second, cover half. First and second side gears are provided. The first side gear is adapted and configured to receive a first shaft for driving a first wheel and a second side gear is adapted and configured to receive a second shaft for driving a second wheel. The differential includes a plurality of sets of planet gears. Each set of planet gears includes a first planet gear positioned to engage the first side gear and rotatably mounted on a first pin. Each set also includes a second planet gear positioned to engage the second side gear and rotatably mounted on a second pin. The second pin is operatively connected to the housing. The first planet gear also engages the second planet gear.

In a second embodiment, the invention is a spur gear differential for use in a vehicle. The spur gear differential includes a differential housing having a first, carrier half, operatively connected to a second, cover half. First and second side gears are provided. The first side gear is adapted and configured to receive a first shaft for driving a first wheel and a second side gear is adapted and configured to receive a second shaft for driving a second wheel. The differential includes a plurality of sets of planet gears. Each set of planet gears includes a first planet gear positioned to engage the first side gear and rotatably mounted on a first pin. Each set also includes a second planet gear positioned to engage the second side gear and rotatably mounted on a second pin. The second pin is operatively connected to the housing. The first planet gear also engages the second planet gear. A locking mechanism is provided for locking the first side gear to the second side gear.

In a third embodiment, the invention is a spur gear differential for use in a vehicle. The spur gear differential includes a differential housing having a first, carrier half, operatively connected to a second, cover half. First and second side gears are provided. The first side gear is adapted and configured to receive a first shaft for driving a first wheel and a second side gear is adapted and configured to receive a second shaft for driving a second wheel. The differential includes a plurality of sets of planet gears. Each set of planet gears includes a first planet gear positioned to engage the first side gear and rotatably mounted on a first pin. Each set also includes a second planet gear positioned to engage the second side gear and rotatably mounted on a second pin. The second pin is operatively connected to the housing. The first planet gear also engages the second planet gear. A manual locking mechanism is provided for locking the first side gear to the carrier half.

### BRIEF DESCRIPTION OF THE DRAWINGS

FIG. 1 is an exploded perspective view of the spur gear differential of the present invention;

FIG. 2 is a cross-sectional view taken through the center of the differential shown in FIG. 1, taken generally along the lines 2-2;

FIG. 3 is a view of the differential shown in FIG. 1 to show the interface of the cam plate and cam face in an unlocked position;

FIG. 4 is a view of the differential shown in FIG. 1 to show the interface of the cam plate and cam face in a locked position;

FIG. 5 is a side elevational view of the assembled differential unit shown in FIG. 1 with the differential cover half removed and in an unlocked position;

FIG. 6 is a side elevational view of the assembled differential unit shown in FIG. 1 with the differential cover half removed and in a locked position;

FIG. 7 is an enlarged perspective view of portions of the differential shown in FIG. 1 to show the flyweight governor;

FIGS. 8a and 8b are exploded perspective views, which together, show another embodiment of the present invention showing a manually locked spur gear differential;

FIG. 9 is a perspective view of the assembled differential shown in FIG. 8, with portions broken away;

FIGS. 10a and 10b are enlarged exploded perspective views, which together, show the same view as FIG. 1, only larger for more clarity;

FIG. 11 is a schematic drawing of an ATV or utility vehicle; and

FIG. 12 is an end view of the schematic in FIG. 11.

### DETAILED DESCRIPTION OF A PREFERRED EMBODIMENT

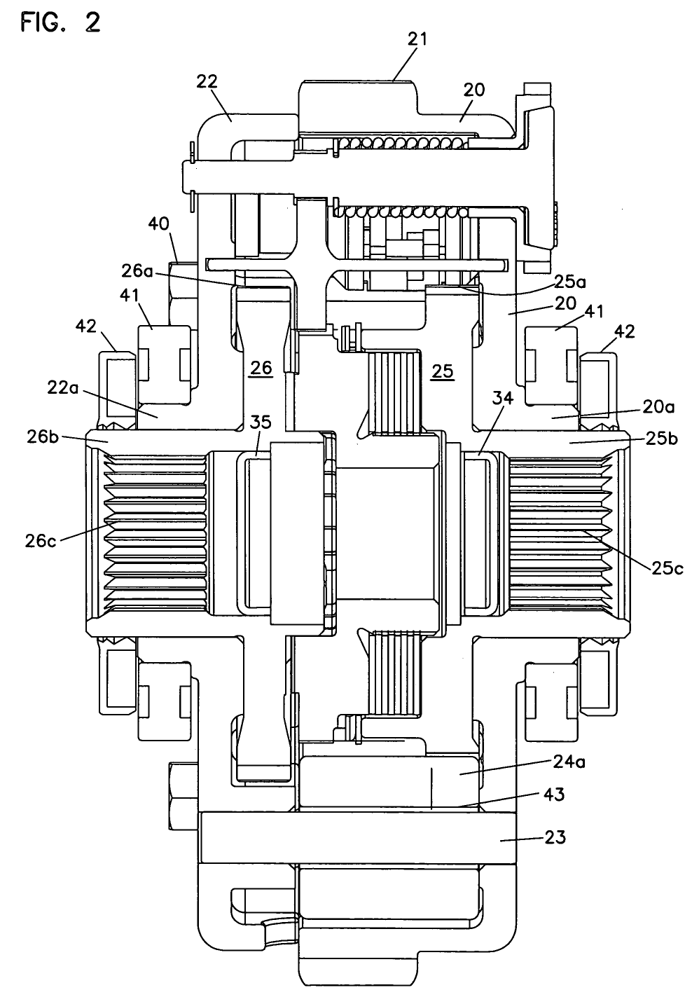

Referring to the drawings, wherein like numerals represent like parts throughout the several views, there is generally disclosed at 10 a spur gear differential having an automatic locking mechanism. FIG. 2 shows the spur gear differential 10 assembled but is a cross-sectional view taken through the center of the spur gear differential 10. The spur gear differential 10 includes a first differential carrier half 20 and a second differential cover half 22. The carrier half 20 and cover half 22 are secured to each other by a plurality of screws 40 to form the outer housing for the spur gear differential 10. The six screws 40 go through the six openings 22c formed in the cover half 22. The screws 40 then are seated in six bosses 20c formed in the carrier half 20. The differential carrier half 20 has a hub 20a which extends outward on which a bearing 41 is positioned. Similarly, the differential cover half 22 has a hub 22a on which a bearing 41 is positioned. The hubs 20a and 22a have a central bore 20b, 22b formed therein. The carrier half 20 has a sprocket 21 formed integral therewith. It is understood that the carrier could also have a separate sprocket, parallel axis gear or bevel gear bolted to it.

Six pins 23 are operatively connected between the carrier half 20 and the cover half 22. The pins 23 are planet gear axles and may be press fit into the carrier half 20 and cover half 22 by suitable means. One way of doing so is to press fit three of the pins 23 into bosses 20d formed in the carrier half 20 and the other three pins 23 into similar bosses formed in the cover half 22. Six bushings or bearings 43 are positioned over the pins 23. There are six planet gears which form three sets of planet gears. Each set is made up of a first planet gear 24a and a second planet gear 24b, as will be more fully described hereafter.

A first side gear 25 has a plurality of teeth 25a around its circumference. The first side gear 25 has a hub 25b that extends through the bore 20b of the hub 20a. A bushing or bearing may be positioned between bore 20b and hub 25b if needed for a particular vehicle application. An oil seal 42 is positioned around the hub 25b proximate the bearing 41. The inside bore of the hub 25b has a plurality of splines 25c. The splines 25c are adapted and configured to be connected to a half shaft of an independent suspension and connected to one of the rear wheels. A second side gear 26 has a plurality of teeth 26a around its circumference. The second side gear 26 has a hub 26b that extends through the bore 22b of hub 22a. An oil seal 42 is positioned around the hub 26b proximate the bearing 41. The hub 26b has a plurality of splines 26c that are adapted and configured to be connected to a second half shaft of an independent suspension that is connected to the other rear wheel. A bushing or bearing may be positioned between bore 22b and hub 26b if needed for a particular vehicle application.

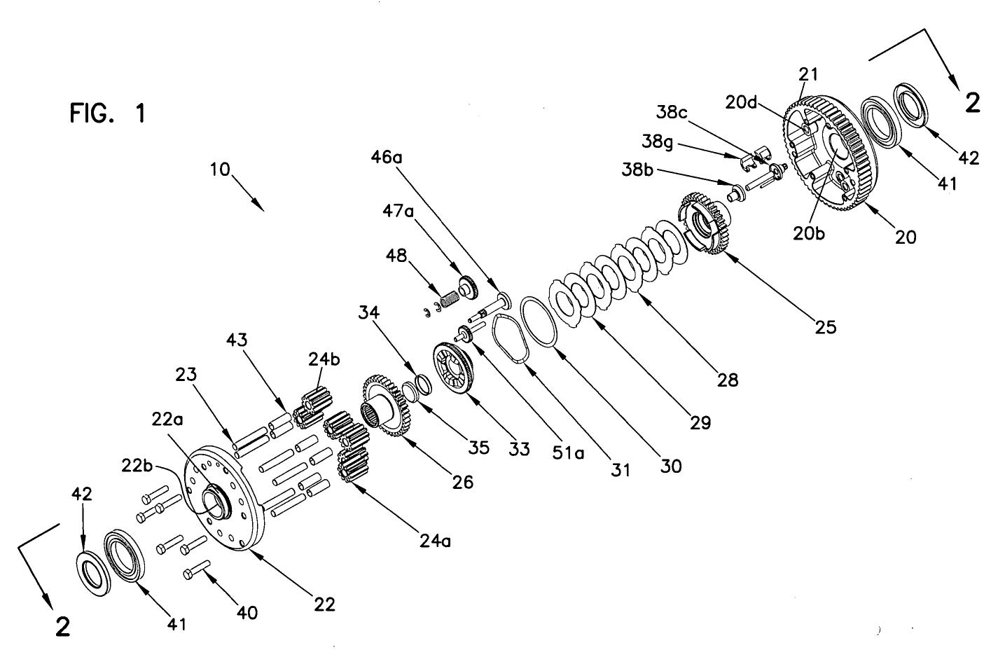

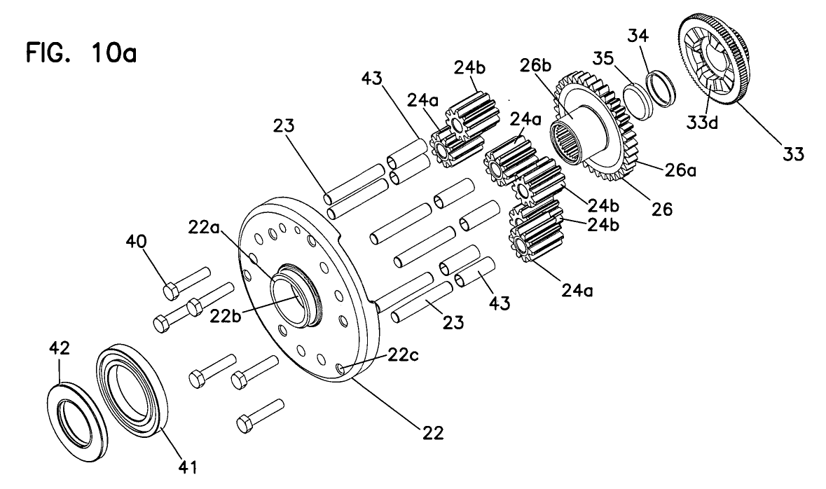

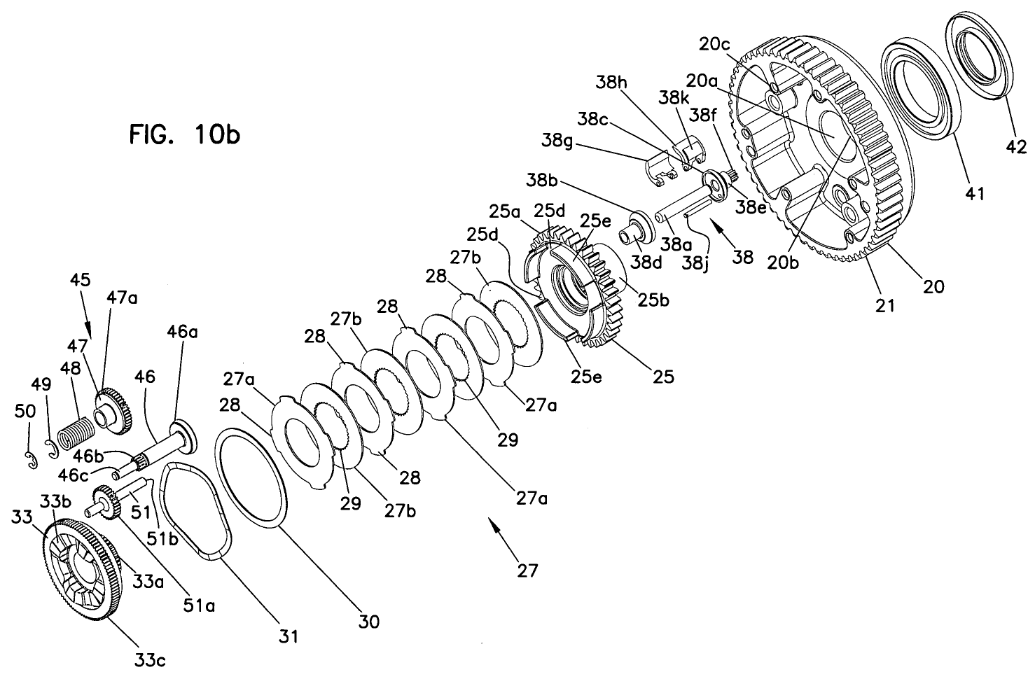

A clutch pack, generally designated at 27, along with a cam plate 33 is positioned between the side gears 25, 26. In FIGS. 10a and 10b, which represent an enlarged view of FIG. 1a, the cam plate 33 is shown in each view, however it is understood that this is only for showing continuity and there is in fact only one cam plate 33 as shown in FIG. 1. The clutch pack 27 includes a plurality of reaction plates 27a alternating with a plurality of friction plates 27b. The reaction plates 27 have four extensions 28 located around their perimeter. The extensions 28 are sized and configured to fit into the four openings or clutch baskets 25d formed in the rim 25e. This ties the reaction plates 27a to the first side gear 25. The friction plates 27b have a splined surface 29 around their central bore that is used to tie the friction plates 27b to the cam plate 33. The cam plate 33 has a hub having a splined surface 33a that is configured and adapted to receive the splines 29. Between the cam plate 33 and the rim 25e are positioned a washer 30 and a wave spring 31. The wave spring 31 is utilized to hold the cam plate 33 together with the second side gear 26, such that they try to rotate as one.

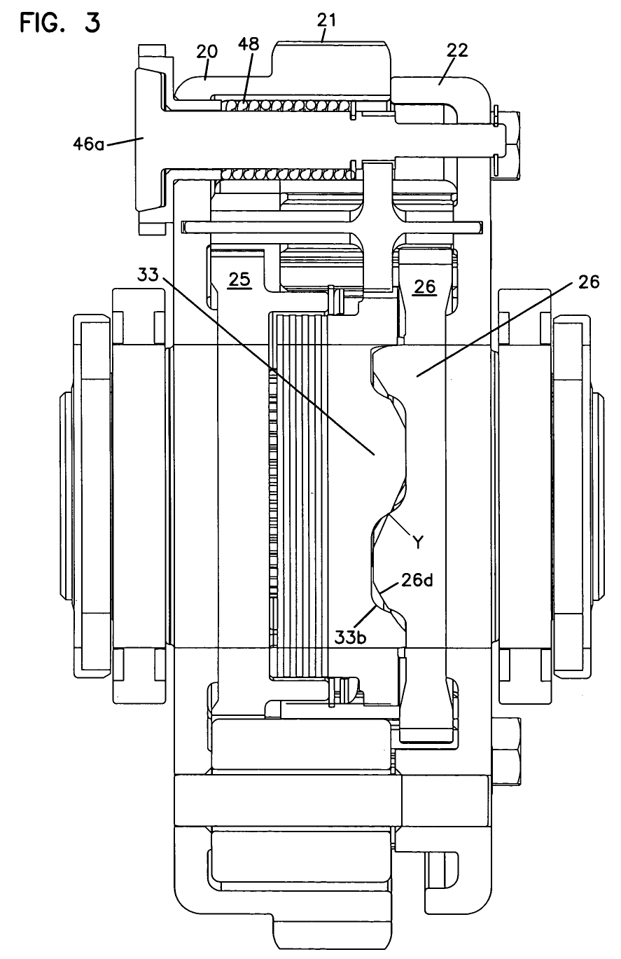

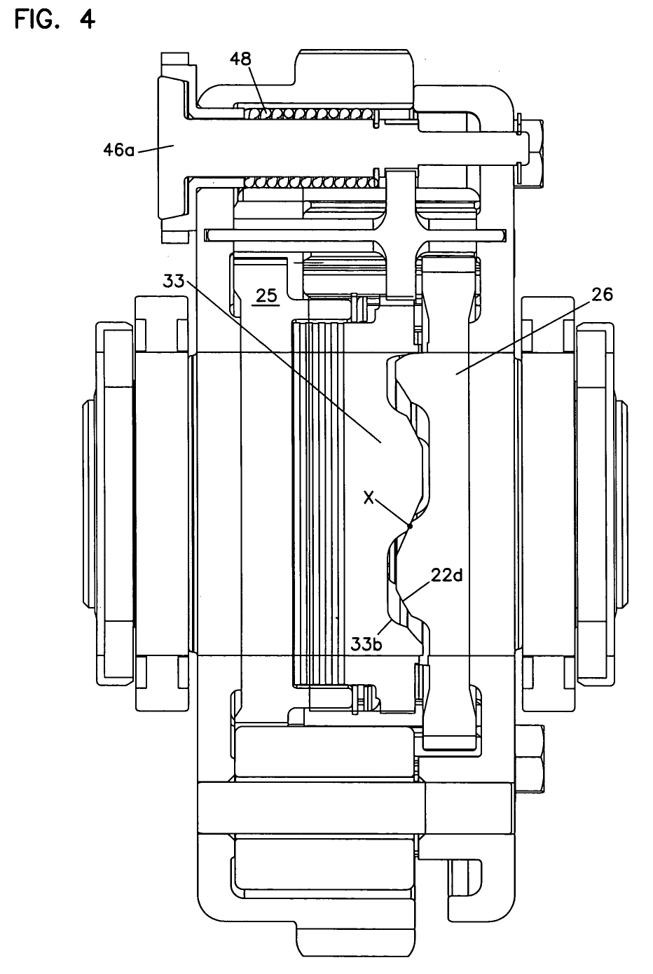

The cam plate 33 has a cam surface 33b as shown generally in FIG. 10b. The cam surface 33b is a helical swept surface. As shown in FIG. 10b, the cam surface 33b has four lobes and four depressions. There is a mating face cam 26d formed integral with the side gear 26. The face cam 26b is best seen in FIGS. 3 and 4 and cooperates with the cam surface 33b. FIG. 3 shows the two surfaces 33b and 26d when the plate 33 and side gear 26 are proximate each other and are not cammed away. Then, when there is a camming action, as will be described more fully hereafter, relative rotation between the cam plate 33 and side gear 26 cams the side gear 26 away from the cam plate 33 as shown in FIG. 4. The cam plate 33 has a plurality of gear teeth 33c around its circumference. While the use of a cam plate and face cam are shown, it is also well known in the art that ball ramps or other suitable mechanisms could also be utilized to translate the rotational movement to lateral movement. Referring to FIG. 3, the point Y represents the portion of both the cam surface 33b and face cam 26d where they are at a sharper angle. Then, point X, as shown in FIG. 4, represents a shallower angle. The benefit of this will be discussed more fully hereafter. Positioned between the side gear 26 and cam plate 33 are an expansion plugs 34 and 35. The expansion plugs 34, 35 seal the inner bore of each side gear.

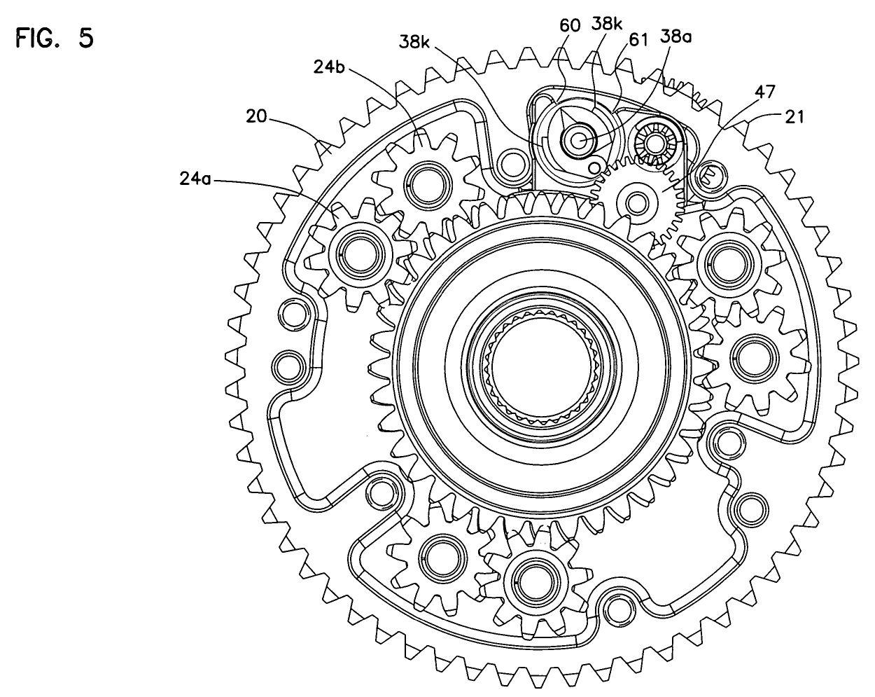

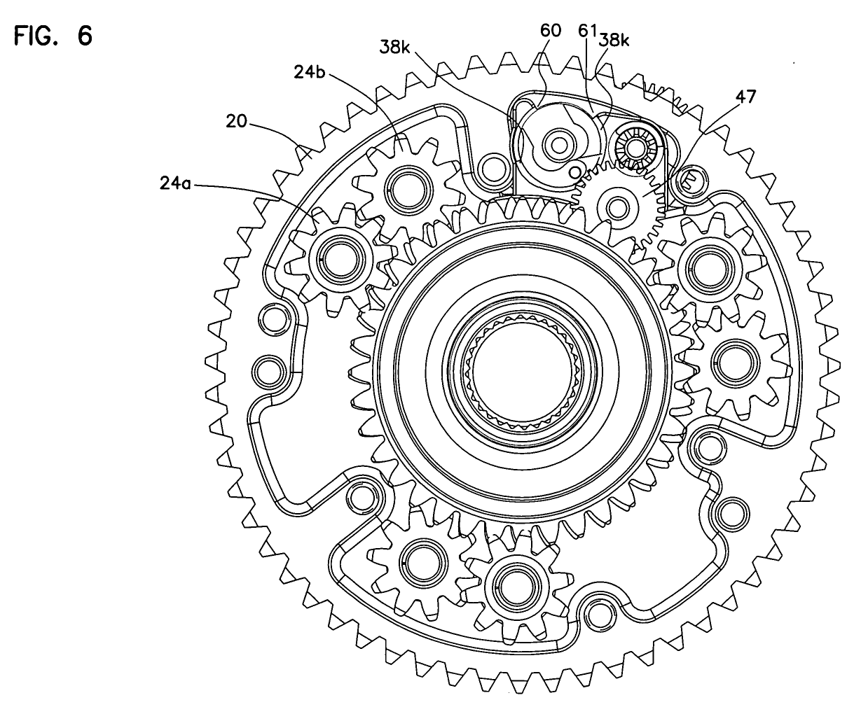

Referring now to FIGS. 10a, 10b, 5, 6 and 7, a flyweight assembly, generally designated at 38 is shown. The flyweight assembly 38 includes a shaft 38a positioned between two end caps 38b and 38c. The end caps each have a protruding hub 38d, 38e. Operatively connected to the hub 38e is a gear 38f. Rotation of the gear 38f causes rotation of the shaft 38a and end caps 38b, 38c. Positioned on opposite sides of the shaft 38a are two flyweights 38g and 38h. The flyweights are mounted via a shaft 38j that is secured between the end caps 38d and 38e. The flyweights 38g and 38h have yokes through which the shaft 38j passes. The flyweights are normally as shown in FIG. 5 and, upon rotation that is sufficient, fly outwards to the position shown in FIG. 6, as we describe more fully hereafter. A torsion spring (not shown) pilots on shaft 38j and holds flyweights 38g and 38h inward. Such a flyweight assembly is known in the art. The flyweights 38g and 38h each have a raised portion 38k which form a locking member to interact with the differential carrier half 20 as will be described more fully hereafter.

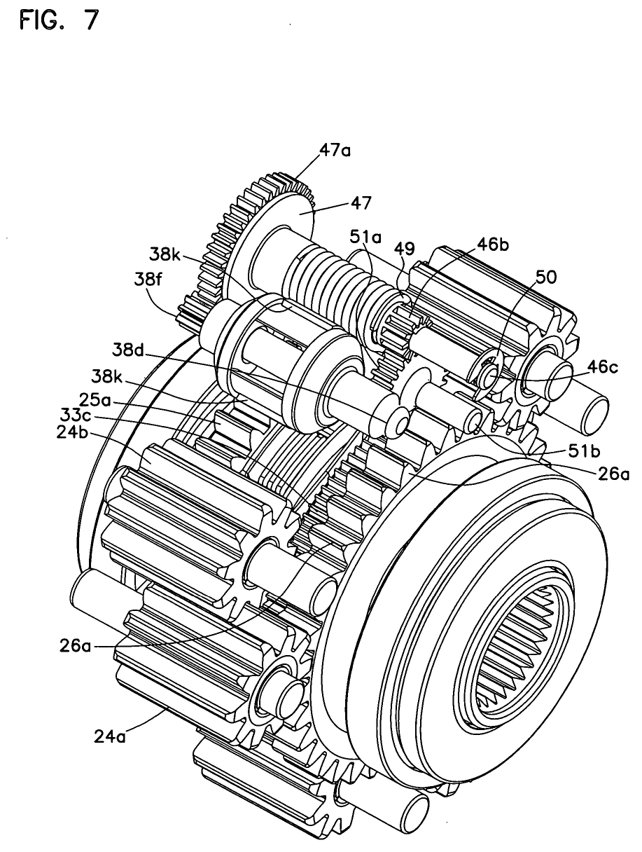

Referring now especially to FIG. 10b and FIG. 7, there is generally shown a gear train, designated at 45 that rotationally connects the cam plate 33 to the flyweight assembly 38. The gear train 45 includes a governor cone clutch gear shaft 46 having a conical surface 46a. On the shaft 46 is a gear 46b and the shaft terminates at an end 46c. The shaft end 46c is operatively connected to the cover half 22 by suitable means such as a bore sized and configured to receive the end 46c. A governor gearing with cone clutch 47 having gear teeth 47a has a central bore through which the end 46c is inserted such that the conical surface 46a will match up with the cone clutch portion of the governor gearing with cone clutch 47. A governor slip clutch spring 48 is positioned around the shaft 46 and is held in position with a c-clip 49. A similar c-clip 50 is positioned at the end of the shaft 46c. The end of the shaft 46c is also sized and configured to fit within a bore formed in the cover half 22. A governor gearing idler shaft 51 has gear teeth 51 a and an end 51b. The end 51b is sized and configured to fit within a bore inside of the carrier half 22. When assembled, as seen in FIG. 7, the gear teeth 51a mesh with the gear teeth 33c of the cam plate 33. The gear teeth 51a mesh with the gear 46b. Rotation of the gear 46b causes rotation of the shaft 46 which also rotates the gear 47a which in turn meshes with gear 38f causing rotation of the shaft 38a and therefore rotation of the flyweights 38g and 38k. The gearing is set so that a smaller rotation of the cam plate 33 relative to the housing will cause sufficient rotation of the shaft 38a to cause the flyweights to fly out at a pre-selected speed.

FIGS. 5 and 6 show the differential 10 with the cover half 22 removed and those Figures show the locking that may be caused by the flyweight assembly 38. The cavity inside of carrier half 20 has a specific contour proximate where the flyweight assembly 38 is located. Referring now to FIG. 5, the contour has two areas that protrude proximate the flyweight assembly 38. These protrusions form locking members 60 and 61. In FIG. 5, the flyweights are in an unlocked position. That is, as the flyweights rotate around shaft 38a, either clockwise or counterclockwise, the locking members 38k are free to rotate without hitting the protrusions 60 or 61. However, when the rotational speed of the flyweight is sufficient so that they fly outward, away from the shaft 38a, the locking member 38k will hit locking member 61 thereby locking the differential 10, as will be discussed more fully hereafter. If the relative rotation between the cam plate 33 and the housing was rotating in the opposite direction, so as to cause the flyweight to spin in the opposite direction, then the locking point 38k would hit locking member 60 again locking the differential 10.

The planet gears 24a are positioned on the pins 23 such that the planet gears 24a mesh with the gear teeth 26a of the second side gear 26 and not with gear teeth 25a of the first side gear 25. The planet gears 24b are positioned on the pins 23 such that they mesh with the gear teeth 25a of the first side gear 25 and not with the gear teeth 26a. The planet gears 24a do mesh with their adjacent planet gear 24b. It can be seen from the drawing that there are three sets of planet gears 24a, 24b that are utilized. Therefore, each set of planet gears includes one planet gear 24a and one planet gear 24b. The planet gears mesh with each other. However, the planet gear 24a meshes only with side gear 26 and planet gear 24b meshes only with the first side gear 25. Having multiple sets of planet gears allow for the stress and load to be shared, thereby allowing the planet gears 24a, 24b to be smaller and narrower, thereby allowing for the side gears 25, 26 to also be narrower in width.

The operation of the spur gear differential 10 will now be described in detail. In a differential, when there is either a difference in torque being applied to the wheels or normal turning, there is relative motion between the carrier and side gear. In the present spur gear differential 10, since the cam plate 33 is tied to the second side gear 26, if there is differentiation between the side gears 25 and 26 there will be relative rotation between the cam plate 33 and the first side gear 25. As previously described, during this differentiation, a first group of planet gears 24a are meshed with the gear teeth 26a and the second group of planet gears 24b mesh with the gear teeth 25a of the first side gear and at the same time their respective planet gears 24a are meshing with the planet gears 24b. The relative motion or rotation of the cam plate 33 relative to the housing is multiplied through the gear train assembly 45 which in turn causes the flyweight assembly 38 to rotate. When the rotational motion is sufficient, the centrifugal force acting on the flyweights 38g, 38k causes them to overcome the spring holding them in.

The flyweights 38h and 38g then fly out and the locking member 38k locks against the contoured profile of the differential carrier half 20 at either locking point 60 or 61, depending upon the direction of rotation. Once this happens, the gear train 45, including the cam plate 33, has no relative motion with respect to the carrier half 20. Any additional differentiation causes the cam plate 33 to move away from the side gear 26, creating an axial load through the clutch pack 27, which in turn locks the differential 10. The clutch pack 27 locks the cam plate 33 to the side gear 25. Because the cam plate 33 is already connected to the side gear 26, the clutch 27 is locking the two side gears 25, 26 to each other. The angles on the face cam 26d and cam surface 33b are designed such that it is self-energizing. That is, the angles at point Y are steep and those at point X are relatively shallow. These angles would change depending upon the specific configuration. To keep viscous drag and other internal friction from applying the initial torque needed to initiate the self-energizing locking, a wave spring 31 applies axial force to keep the clutch open. In the unlocked state, there may also be a detent built into the face cam to ensure that the cam plate 33 cannot start the locking process until the flyweight assembly 38 initiates it. This would be the steeper angle portion shown at Y in FIG. 3. To unlock the differential 10, a torque reversal, which means that the cam plate 33 is then rotating in the opposite direction, would relieve the wedging force in the clutch pack, allowing the spring 31 to push the cam plate 33 back to the unlocked position. The engagement rpm of the flyweight assembly 38 is set sufficiently high so that differentiation would not attempt to lock the differential 10 under normal turning situations.

Within the gear train 45, there is a slip mechanism provided. This is the conical surface 46a against the governor gearing cone clutch 47. This limits the torque within the gear train 45 and allows some rotation of the cam plate 33 relative to the carrier 20 during the locking stage.

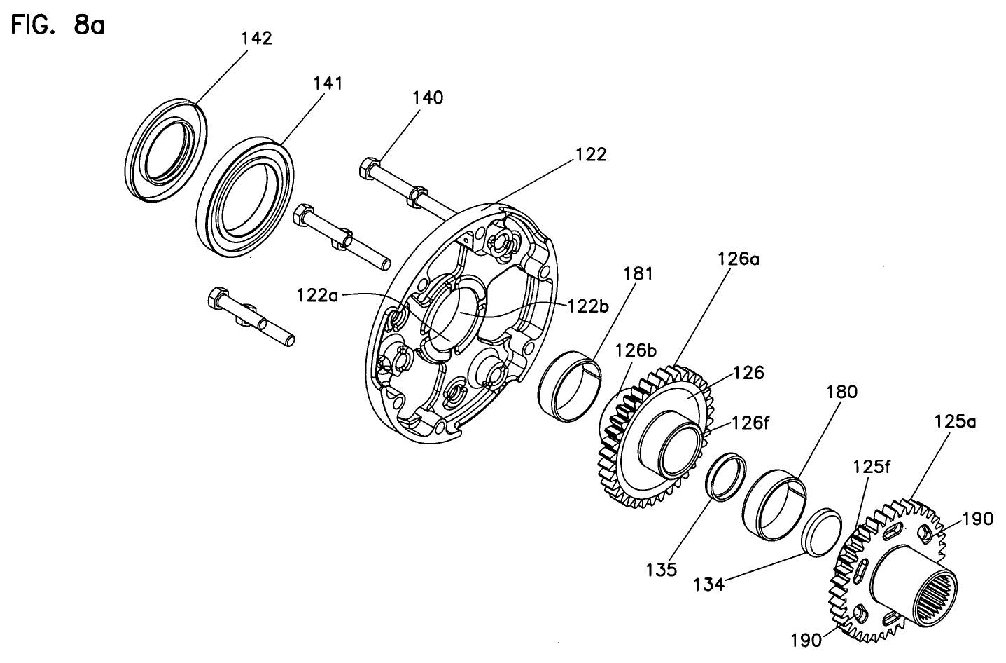

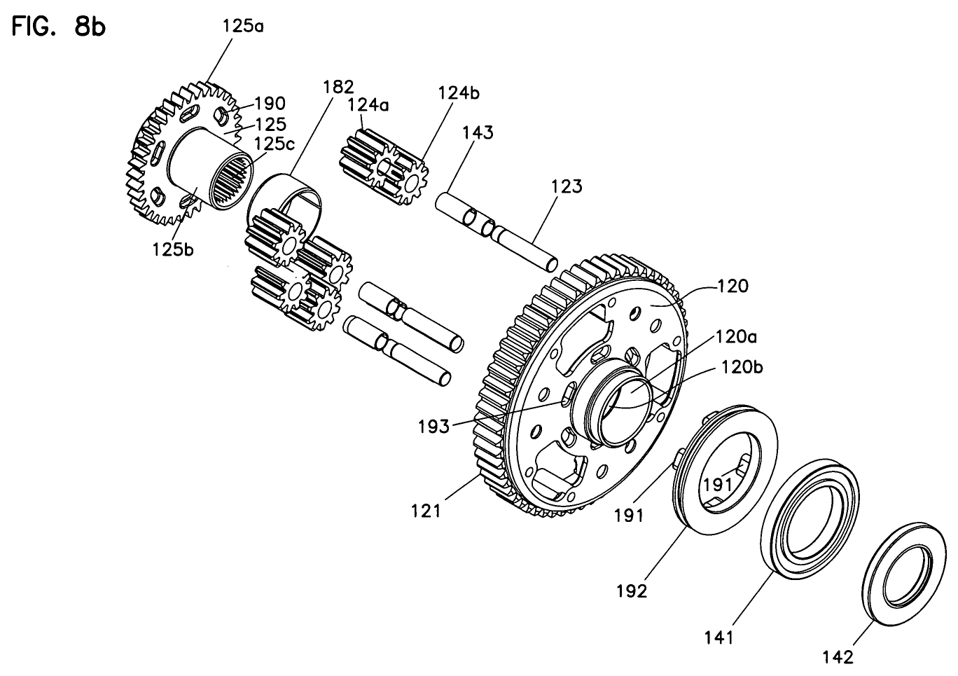

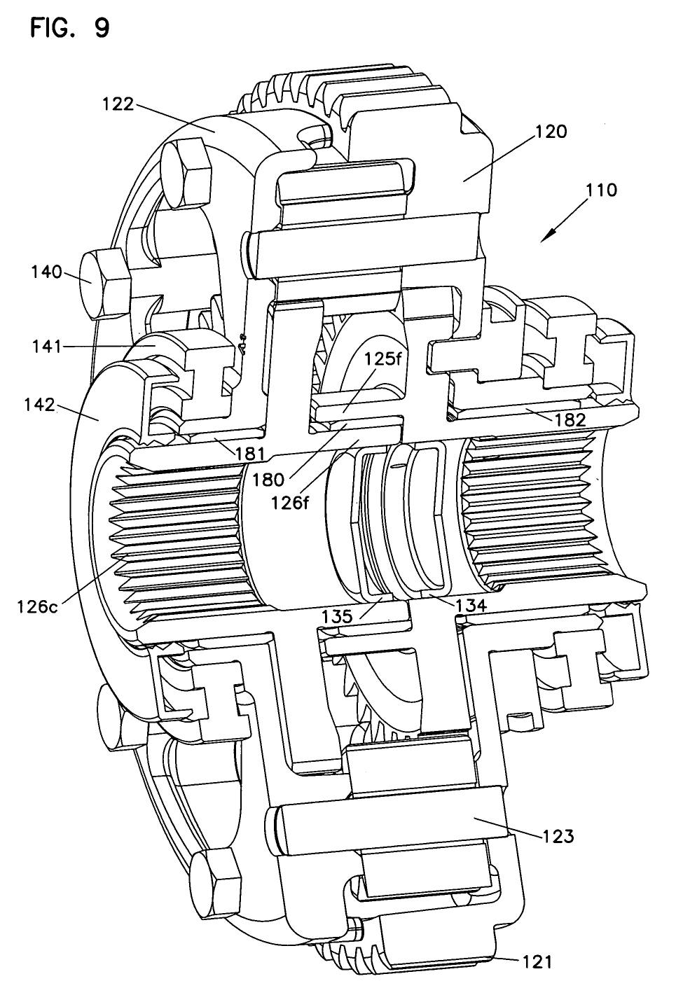

Referring now to FIGS. 8a, 8b and 9, there is shown a second embodiment of the present invention. The manually locking spur gear differential 110 is quite similar in construction to the spur gear differential 10, except a manual engagement is used. The spur gear differential 110 includes a first differential carrier half 120 having an integral sprocket 121 and a second differential cover half 122. The carrier half 120 and cover half 122 are secured to each other by a plurality of screws 140 to form the outer housing for the spur gear differential 110, in a similar manner as that described with respect to spur gear differential 10. The differential carrier half 120 has a hub 120a which extends outward on which a bearing 141 is positioned. Similarly, the differential cover half 122 as a hub 122a on which a bearing 41 is positioned. The hubs 120a and 122a have a central bore 120b, 122b formed therein.

Six pins 123 are operatively connected between the carrier half 120 and the cover half 122. The pins 123 are planet gear axles and may be press fit into the carrier half 120 and cover half 122 by suitable means, such as that which was described to spur gear differential 10. Six bushings or bearings 143 are positioned over the pins 123. There are six planet gears which form three sets of planet gears. Each set is made up of a first planet gear 124a and a second planet gear 124b.

A first side gear 125 has a plurality of gear teeth 125a around its circumference. It should be noted that the first side gear 125 is shown twice, once in FIG. 8a and once in FIG. 8b, it being understood that there is only one side gear 125. However, the side gear 125 is shown in both figures for continuity purposes. The first side gear 125 has a hub 125b that extends through the bore 120b of the hub 120a. An oil seal 142 is positioned around the hub 125b proximate the bearing 141. The inside bore of the hub 125b has a plurality of splines 125c. The splines 125c are adapted and configured to be connected to a half shaft of an independent suspension and connected to one of the rear wheels. A second side gear 126 has a plurality of gear teeth 126a around its circumference. The second side gear 126 has a hub 126b that extends through the bore 122b of hub 122a. An oil seal 142 is positioned around the hub 126b proximate the bearing 141. The hub 126 has a plurality of splines 126c that are adapted and configured to be connected to a second half shaft of an independent suspension that is connected to the other rear wheel.

The side gears 125 and 126 have an additional hub 125f, 126f that extends toward each other. As shown in FIG. 9, the hub 125f is larger in diameter and extends around the hub 126f. A bushing 180 is positioned between the hubs 126f, 125f. A bushing 181 is positioned over the hub 126b and a bushing 182 is positioned over the hub 125b. The bushings 181, 182 support the side gears. The bushings 181, 182 help keep the side gears in alignment. The plugs 134, 135 seal the inner bore of each side gear.

The side gear 125 has six slots 190 formed thereon. The slots 190 are sized and configured to receive the six engagement members 191 formed on the engagement dog clutch 192. The six slots 193 are formed in the carrier half 120. The engagement dog clutch 192 has a bore that is positioned around the hub 120b. The engagement dog clutch 192 may be activated by any means well known in the art such as by solenoid. The activation of a solenoid or other means would move the engagement clutch to the left, as viewed in FIG. 8b, such that the engagement members 191 will be inserted into the slots 190, thereby locking the side gear 125 to the carrier 120. Once the side gear 125 is locked to carrier 120, then gears 124a, 124b and side gear 126 are also loaded due to the way the gears mesh, as previously described.

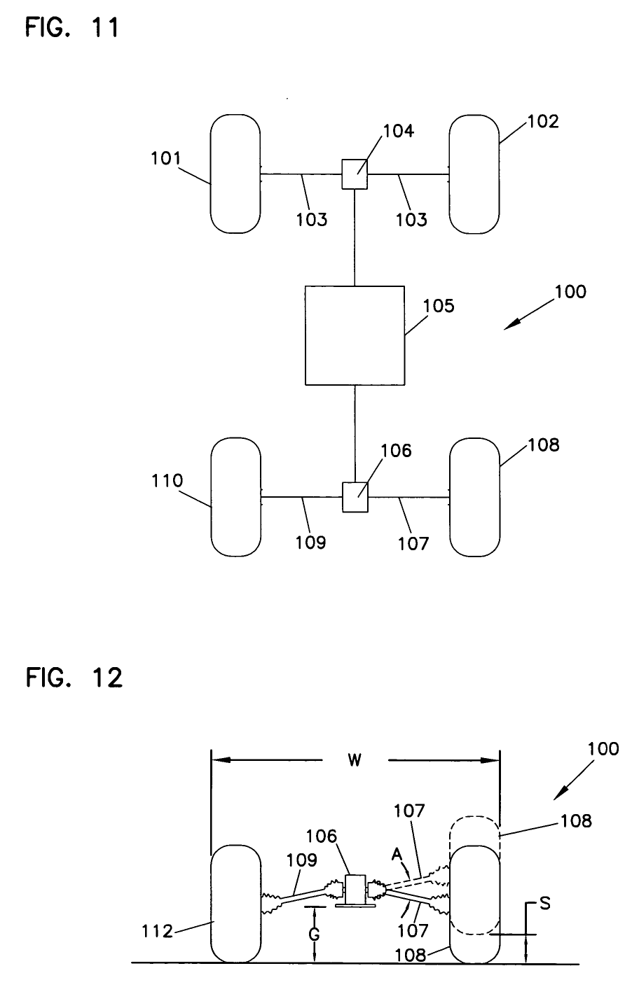

Referring now to FIGS. 11 and 12, there is schematically shown a vehicle 100. The vehicle 100 is preferably an all terrain vehicle or a utility vehicle. When used in this application and in the claims, the term “vehicle” refers to both an all terrain vehicle and a utility vehicle. The spur gear differential 10, 110 may be utilized in such a vehicle. Generally, the vehicle 100 includes front tires 101 and 102 having a front axle 103 and a front axle gear box 104. An engine/transmission is schematically shown as 105 and is operatively connected to a rear axle gear house 106 that would contain the spur gear differential 10, 110. Connected by a first one-half shaft 107 is a first rear tire 108. A second one-half shaft 109 is operatively connected to the second rear tire 112. The half-shafts 107, 109 are operatively connected to the gear box 106. Referring now to FIG. 12, the vehicle 100 has an overall width of W. The bottom of the chassis 111 defines the ground clearance G in connection with the ground. The wheel 108 is shown in two positions, an upper position and a lower position. The distance S represents the suspension travel. The half-shaft 107 has an operating angle A. It is of course understood that the vehicle could have any number of suitable configurations. For instance, a vehicle could have an engine and transmission combined into one unit with drive shafts going to the front and rear wheels, which would contain right angle gears. A vehicle could also have an engine, transmission, front drive and rear drive, all of separate components. Further, the transmission and rear drive could be integrated into one unit (transaxle). The spur gear differential 10, 110 could be utilized with any suitable layout for a vehicle. The load sharing by the planet gears which results in narrower planet gears and side gears allow for the overall width to be less. Further, this narrow width allows for the angle of operation of the half-shafts to be narrower, which is preferred over a larger suspension travel S.

While the invention so far has been described with respect to a rear drive, it is also understood the spur gear differential 10, 110 may also be used in a front drive as well.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A spur gear differential for use in a vehicle, the spur gear differential comprising:
(a) a differential housing having a first, carrier half, operatively connected to a second, cover half;
(b) first and second side gears, the first side gear adapted and configured to receive a first shaft for driving a first wheel and the second side gear adapted and configured to receive a second shaft for driving a second wheel; and
(c) a plurality of sets of planet gears, each set comprising:
(i) a first planet gear positioned to engage the first side gear and rotatably mounted on a first pin, the first pin operatively connected to the housing; and
(ii) a second planet gear positioned to engage the second side gear and rotatably mounted on a second pin, the second pin operatively connected to the housing, the first planet gear also engaging the second planet gear.

2. A locking spur gear differential for use in a vehicle, the spur gear differential comprising:
(a) a differential housing having a first, carrier half, operatively connected to a second, cover half,
(b) first and second side gears, the first side gear adapted and configured to receive a first shaft for driving a first wheel and the second side gear adapted and configured to receive a second shaft for driving a second wheel;
(c) a plurality of sets of planet gears, each set comprising:
(i) a first planet gear positioned to engage the first side gear and rotatably mounted on a first pin, the first pin operatively connected to the housing; and
(ii) a second planet gear positioned to engage the second side gear and rotatably mounted on a second pin, the second pin operatively connected to the housing, the first planet gear also engaging the second planet gear; and
(d) a locking mechanism for locking the first side gear to the second side gear.

3. The locking spur gear of claim 2, wherein the locking mechanism is automatic.

4. The spur gear differential of claim 2, the automatic locking mechanism further comprising a clutch pack positioned between the side gears.

5. The spur gear differential of claim 4, further comprising:
(a) a cam plate positioned on one side of the clutch pack;
(b) a flyweight governor having a locking member;
(c) a gear train operatively connecting the cam plate to the flyweight governor; and
(d) the housing having a locking surface, wherein when the cam plate rotates at a given speed, the flyweight governor locking member moves outward and locks against the locking surface so that there is no relative motion with respect to the carrier housing and any further differentiation creates an axial load on the clutch pack which in turn locks the side gears to each other.

6. The spur gear differential of claim 5, the locking surface comprising a first locking surface and a second locking surface, wherein rotation in either direction will lock the locking member against the housing.

7. The spur gear differential of claim 6 wherein the cam plate is self energizing.

8. The spur gear differential of claim 7 wherein the cam plate is activated by a cam face.

9. A locking spur gear differential for use in a vehicle, the spur gear differential comprising:
(a) a differential housing having a first, carrier half, operatively connected to a second, cover half;
(b) first and second side gears, the first side gear adapted and configured to receive a first shaft for driving a first wheel and the second side gear adapted and configured to receive a second shaft for driving a second wheel;
(c) a plurality of sets of planet gears, each set comprising:
(i) a first planet gear positioned to engage the first side gear and rotatably mounted on a first pin, the first pin operatively connected to the housing; and
(ii) a second planet gear positioned to engage the second side gear and rotatably mounted on a second pin, the second pin operatively connected to the housing, the first planet gear also engaging the second planet gear; and
(d) a manual locking mechanism for locking the first side gear to the housing.

10. The spur gear differential of claim 9, the manual locking mechanism comprising:
(a) the carrier half having a plurality of openings;
(b) the first side gear having a plurality of openings; and
(c) a dog engagement member having a plurality of engagement members the engagement members sized and configured to move through the openings of the carrier half and into the openings of the first side gear, wherein when moving from an unengaged position to an engaged position, the engagement members move into the openings of the first side gear and lock the first side gear to the housing and the planet gears locking the second side gear.
